(19) United States
(12) Patent Application Publication
(10) Pub. No.: US 2009/0063719 A1
(43) Pub. Date: Mar. 5, 2009

(54) RELAY DEVICE, RELAY METHOD AND RELAY CONTROL PROGRAM

(75) Inventors: Nobuyuki HONJO, Kawasaki (JP); Yukihiro Yoshiya, Kawasaki (JP); Atsuhiro Otaka, Kawasaki (JP); Hidetoshi Satou, Kawasaki (JP); Omar Thielo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/193,320

(22) Filed: Aug. 18, 2008

(30) Foreign Application Priority Data
Aug. 30, 2007 (JP) 2007-224722

(51) Int. Cl. G06F 13/38; G06F 13/00

(52) U.S. Cl. 710/8; 710/74

(57) ABSTRACT

A relay device having a plurality of physical ports connecting with a storage medium and relaying data between a higher level device storing configuration information of a storage device and the storage medium, the relay device including a notification unit for issuing a status change notification reporting that a status of the storage medium connected with said physical port changes to said higher level device when the status change of the storage medium is detected, a monitor of status change notification frequency for monitoring whether the frequency of the status change notification informed via said physical port exceeds a specific threshold, and an invalidation unit for invalidating a function of said physical port when said monitor of status change notification frequency detects that the frequency of the status change notification informed via said physical port exceeds the specific threshold.

### CROSS-REFERENCE TO RELATED APPLICATIONS

This application is related to and claims priority to Japanese patent application no. 2007-224722 filed on Aug. 30, 2007 in the Japan Patent Office, the entire contents of which are incorporated by reference herein.

### BACKGROUND OF THE INVENTION

1. Field

An aspect of the present invention relates to a relay device, a relay method and a relay control program. The present invention relates to a relay device, a relay method and a relay control program with which a higher level device is capable of handling a configuration information update process of a storage medium even when the status of the storage medium changes at frequent intervals.

2. Description of the Related Art

Storage devices have recently, employed Serial Attached SCSI (SAS) or Serial Advanced Technology Attachment (SATA) as connection standards for storage media including hard disks (refer to Japanese Laid-open Patent Publication 2006-072636). For some of the storage devices, configuration information is updated automatically by a control unit, such as a higher level device. The control unit stores connector architecture of the storage medium as the configuration information. When the storage medium is removed or mounted or an error occurs in which data cannot be written on the storage medium, the status of the storage medium changes.

The relay device for relaying data between the higher level device and the storage medium is provided in the storage device. The relay device has a physical port with SAS standard or SATA standard. When a status of a storage medium connected with the physical port changes, the relay device notifies the status change to the higher level device by broadcasting. After receiving the notification, the higher level device obtains the statuses of the storage media via each physical port in the relay device. The higher level device also updates the configuration information according to the obtained information. Thus, the higher level device updates the configuration information stored therein automatically.

However, with the prior art described above, the higher level device cannot complete the configuration information update when the relay device issues the notifications continuously before a preceding configuration information update is completed.

For example, if the higher level device processes a configuration information update once per second and the relay device issues two notifications per second, the higher level device continues to update the configuration information.

As the case described above, when a frequency of the status change of the storage medium is too high, the higher level device is incapable of handling the configuration information updates. Thus, the higher level device always lags behind the latest information of the status change while the status of the storage medium changes. Under the circumstances, a write command may be issued to an unwritable storage medium, resulting in an error.

### SUMMARY

In accordance with an aspect of the present embodiment, a relay device has a plurality of physical ports connected to a storage medium and relaying data between a higher level device storing configuration information of a storage device and the storage medium, the relay device including a notification unit for issuing a status change notification reporting that a status of the storage medium connected with said physical port changes to said higher level device when the status change of the storage medium is detected, a monitor of status change notification frequency for monitoring whether the frequency of the status change notification informed via said physical port exceeds a specific threshold, and an invalidation unit for invalidating a function of said physical port when said monitor of status change notification frequency detects that the frequency of the status change notification informed via said physical port exceeds the specific threshold.

The above-described embodiments of the present invention are intended as examples, and all embodiments of the present invention are not limited to including the features described above.

### BRIEF DESCRIPTION OF THE DRAWINGS

FIG. 1 is a schematic illustration of a relay device according to an embodiment of the invention;

FIG. 2A and FIG. 2B are block diagrams showing a structure of a storage device according to an embodiment of the invention;

FIG. 3 is a table showing frequencies of status change notification;

FIG. 4 is a table showing a threshold;

FIG. 5 is a flow chart showing a physical layer (Phy) invalidation process executed by a relay device according to an embodiment of the invention;

FIG. 6 is an example of a table showing thresholds for each Phy;

FIG. 7 is an example of a table showing times when the status change notifications are issued;

FIG. 8 is a function block diagram of the relay device for executing a relay control program; and

FIG. 9 is a function block diagram showing a structure of the storage device.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Referring to accompanying drawings, a preferred embodiment of the relay device, relay method and relay control program will be described. Accordingly, an embodiment of the invention, as set forth herein, is intended to be illustrative, not limiting.

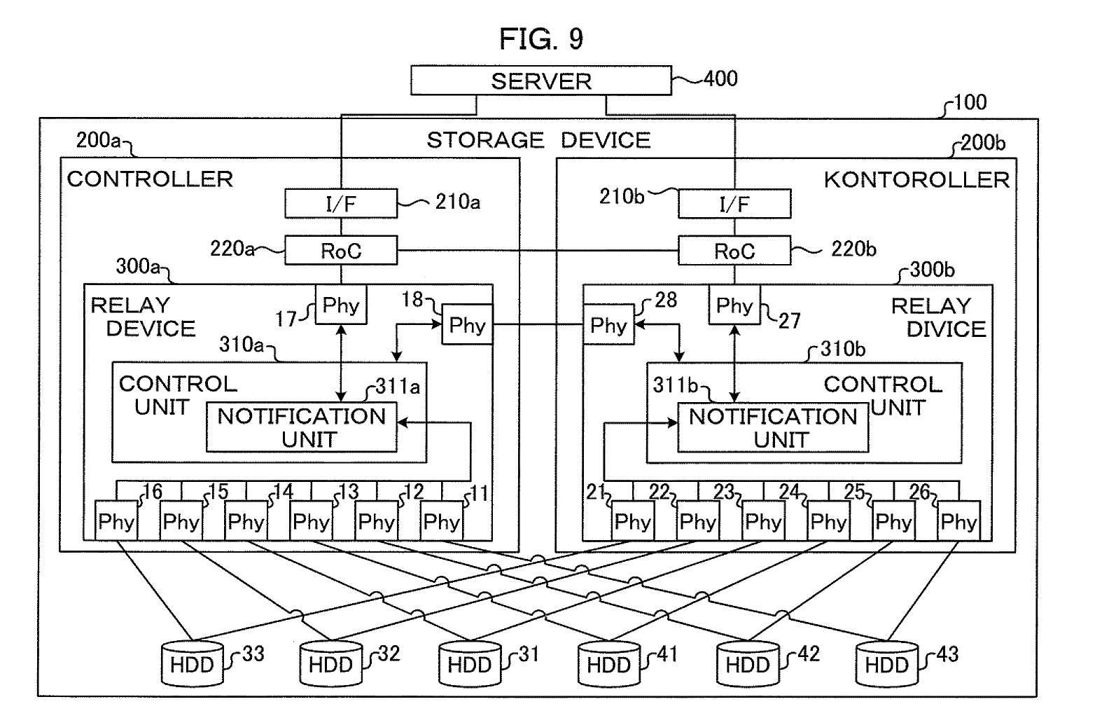

First, a structure of the storage device having physical ports with SAS or SATA standard and a configuration information update process of the storage device will be disclosed. FIG. 9 is a function block diagram showing a structure of the storage device. FIG. 9 shows an example of the storage device having double-structured units.

As shown in FIG. 9, storage device 100 connects with server 400 having controllers 200a and 200b. Server 400 stores information shared with a personal computer not shown in FIG. 9, rendering specific services to the personal computer, and commanding storage device 100 to obtain or store data.

Controller 200a connects with hard disk drives (HDDs) 31 through 33 and 41 through 43, having interface (I/F) 210 a and RAID-on-chip (hereinafter called RoC) 220a and relay device 300a. Similarly, controller 200b connects with HDDs 31 through 33 and 41 through 43, having I/F 210b and RoC 220b and relay device 300b.

HDDs 31 through 33 and 41 through 43 comply with SAS or SATA. Storage media connected with relay devices 300a and 300b are not limited to the HDDs. Optical disks are also available. I/Fs 210a and 210b transmit data between server 400 and the corresponding RoCs.

RoCs 220a and 220b receive commands issued by server 400 via I/Fs 210a and 210b and execute the commands. For instance, RoCs 220a and 220b obtain data from HDDs 31 through 33 or 41 through 43 via relay devices 300a or 300b on receiving a command to obtain data issued by server 400. Then the RoCs 220a or 220b transmit the obtained data to server 400 via I/Fs 210a and 210b.

RoC 220a stores connector architecture of all storage media included in storage device 100 as the configuration information. With reference to FIG. 9, the configuration information relates to connector architecture of HDDs 31 through 33 and 41 through 43 and a structure of HDDs 31 through 33 and 41 through 43 in Redundant Arrays of Inexpensive Disks (RAID). Similarly, RoC 220b stores connector architecture of all the storage media included in storage device 100 as the configuration information.

Relay device 300a relays data between RoC 220a and HDDs 31 through 33 and 41 through 43, and is connected to physical layers (Phys) 11 through 18 and control unit 310a. Similarly, relay device 300b relays data between RoC 220b and HDDs 31 through 33 and 41 through 43, and is connected to Phys 21 through 28 and control unit 310b. Relay devices 300a and 300b are called expanders.

Phys 11 through 18 are physical ports with SAS or SATA, connecting relay device 300a and other devices on a bus. More particularly, Phys 11 through 16 connect with relay device 300a and one of HDDs 31 through 33 and 41 through 43 respectively. Phy 17 connects with relay device 300a and RoC 220a. Phy 18 connects with relay devices 300a and 300b.

Similarly, Phys 21 through 28 are physical ports with SAS or SATA. Phys 21 through 26 connects with relay device 300b and one of HDDs 31 through 33 and 41 through 43. Phy 27 connects with relay device 300b and RoC 220b. Phy 28 connects with relay devices 300b and 300a.

Control unit 310a controls relay device 300a entirely, having notification unit 311a. Notification unit 311a monitors the HDDs via corresponding Phys 11 through 16. When any of HDDs 31 through 33 or 41 through 43 are removed or mounted, or an error such that any of the HDDs 31 through 33 or 41 through 43 become unwritable occurs, notification unit 311a notifies the change of the HDD's status to RoC 220a via Phy 17 by a broadcasting. Hereinafter the case when the storage medium is removed or mounted, or when the storage medium becomes unwritable is referred to as a status change. Notification unit 311a also notifies the status changes to RoC 220b via Phys 18 and 28, control unit 310b and Phy 27. The notification reporting a status change of a storage medium is called a status change notification hereinafter.

In the status change notification, information informing which HDD changes its status is not included. Consequently, RoCs 220a and 220b cannot identify the HDD which changes its status with the status change notification.

Similarly, control unit 310b controls relay device 300b entirely, having notification unit 311b. Notification unit 311b monitors the HDDs via corresponding Phys 21 through 26. When any of the HDDs changes its status, notification unit 311b notifies the status change to RoC 220b via Phy 27 by broadcasting. Notification unit 311b also notifies the status changes to RoC 220a via Phys 28 and 18, control unit 310a and Phy 17.

Referring to FIG. 9, update process of the configuration information stored in RoCs 220a and 220b will be disclosed. As previously described, notification unit 311a monitors HDDs 31 through 33 or 41 through 43 via corresponding Phys 11 through 16. When the status of any of the HDDs changes, notification unit 311a notifies the status change to RoC 220a concurrently with notifying RoC 220b.

After receiving the status change notification from notification unit 311a, RoC 220a obtains information informing which HDD's status changes via Phy 17, control unit 310a and Phys 11 through 16. At the same time, RoC 220a obtains information informing which HDD's status changes via Phy 17, control unit 310a, Phy 18, Phy 28, control unit 310b and Phys 21 through 26. Then RoC 220a updates the configuration information stored therein according to the information obtained via Phys 11 through 16 and 21 through 26.

After receiving the status change notification from notification unit 311a, RoC 220b obtains information informing which HDD's status changes via Phy 27, control unit 310b and Phys 21 through 26. At the same time, RoC 220b obtains information informing which HDD's status changes via Phy 27, control unit 310b, Phys 28, Phy 18, control unit 310a and Phys 11 through 16. Then RoC 220b updates the configuration information stored therein according to the obtained information. In FIG. 9, the components of storage device 100 are redundant. RoCs 220a and 220b swap the configuration information at predetermined timing and synchronize the configuration information.

Similarly, notification unit 311b monitors HDDs 31 through 33 or 41 through 43 via corresponding Phys 21 through 26. When the status of the HDDs changes, notification unit 311b obtains the information on the change via Phys 21 through 26, and notifies the status change to RoC 220b via Phy 27 concurrently with reporting the change to RoC 220a via Phy 28. As described above, RoCs 220a and 220b update the configuration information on receiving the status change notification according to the information obtained via Phys 11 through 16 and 21 through 26.

In the conventional way, notification units 311a and 311b notify the status change to RoCs 220a and 220b when status of any of the HDDs changes. On receiving the status change notification, RoCs 220a and 220b obtain the information informing which HDD's status changes via Phys 11 through 16 and 21 through 26, updating the configuration information according to the obtained information.

However, for storage device 100 employing the configuration information update process, the higher level device cannot complete the updates when the relay device issues the notifications of status changes continuously before a preceding configuration information update is completed. That is, the information stored in RoCs 220a and 220b lag behind the latest information of the status change while the status of the storage medium is changing. Under the circumstances, a write command may be issued to an unwritable storage medium, resulting in an error.

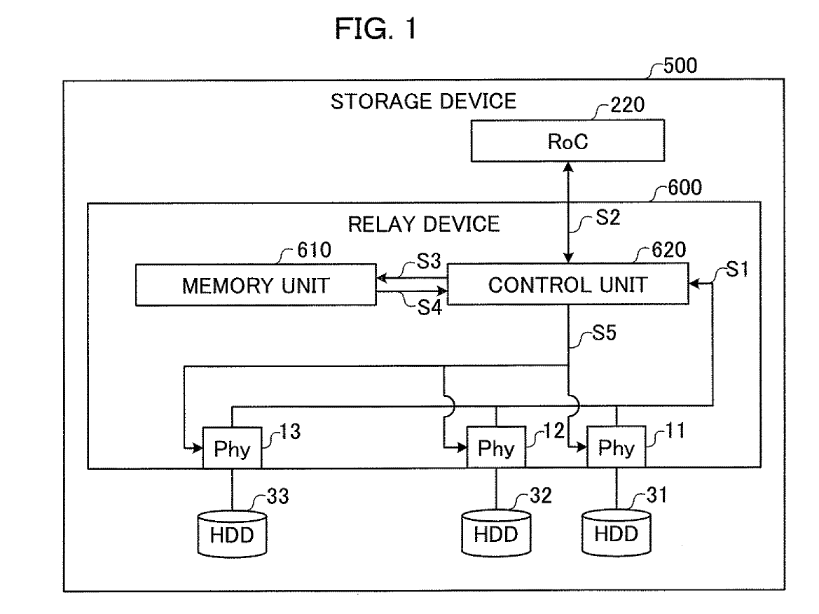

Next, a brief description of the relay device according to this embodiment will be made. FIG. 1 is a diagram showing the schematic of the relay device according to an embodiment of the invention. In the following description, the same components in FIGS. 1 and 9 are assigned the same reference characters. Detailed descriptions of them are omitted to avoid overlaps.

As shown in FIG. 1, storage device 500 has HDDs 31 through 33, RoC 220 and relay device 600. Relay device 600 according to this embodiment has Phys 11 through 13, memory unit 610 and control unit 620.

Memory unit 610 stores the frequency of status change notification per unit time for each Phy. Control unit 620 monitors HDDs 31 through 33 via corresponding Phys 11 through 13. When the status of any of the HDDs changes in operation S1, control unit 620 notifies the status change to RoC 220 in operation S2 and updates the frequency of the status change notification stored in memory unit 610 corresponding to the Phy through which the status change is notified in operation S3.

Control unit 620 monitors whether the frequency of the status change notification for each Phy exceeds the predetermined threshold in operation S4. When the frequency of status change notification informed via any of the Phys exceeds the predetermined threshold, the Phy in which the frequency of status change exceeded the predetermined threshold is disabled in operation S5.

The threshold is defined so as to allow RoC 220 to complete the configuration information update process in good time. Disabling a Phy means the Phy's function is invalidated logically. The disabled Phy cannot recognize the storage media connected thereto. Consequently, even if the storage medium status changes control unit 620 cannot detect the status change, and does not notify the status change.

Accordingly, relay device 600 disables the Phy's function if the frequency of the status change notification notified via the Phy exceeds the threshold that is defined so as to allow RoC 220 to complete the configuration information update process in good time. Thus, RoC 220 can catch up with the frequency of the status change of HDDs 31 through 33. Hence, RoC 220 can complete the configuration information update even the statuses of HDDs 31 through 33 change frequently, allowed to keep the configuration information up-to-date. Allowing the RoC 220 to complete the configuration information update helps to avoid issuing a write command to an unwritable storage medium.

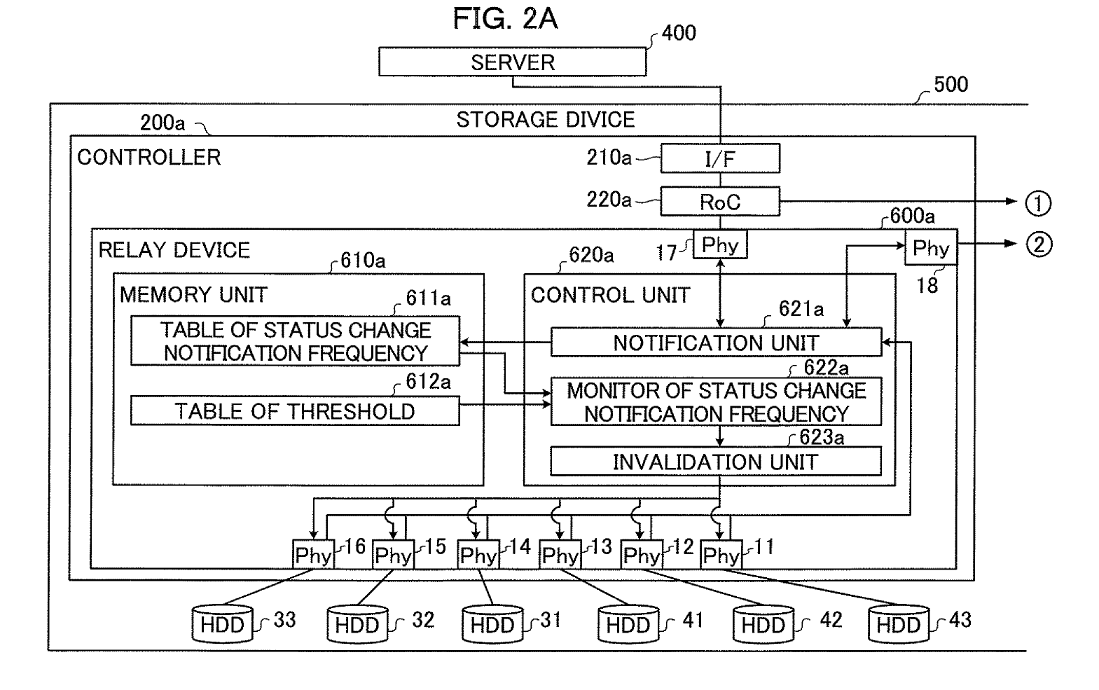

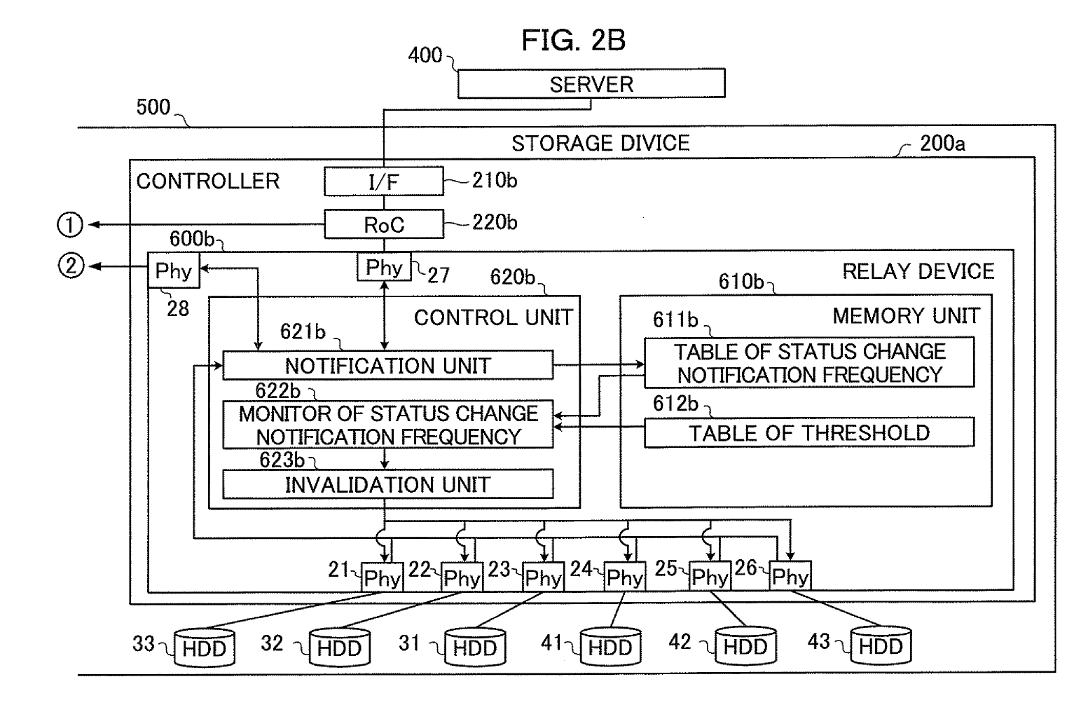

Then the structure of the storage device according to this embodiment will be disclosed. FIG. 2A and FIG. 2B are function block diagrams showing a structure of the storage device. As shown in FIG. 2A and FIG. 2B, storage device 500 has controller 200a having relay device 600a and controller 200b having relay device 600b.

Relay device 600a has memory unit 610a and control unit 620a. Memory unit 610a is a memory device including random access memory (RAM), having status change notification frequency table 611a and threshold table 612a. Similarly, relay device 600b has memory unit 610b and control unit 620b. Memory unit 610b has status change notification frequency table 611b and threshold table 612b.

Status change notification frequency table 611a and threshold table 611b provide information related to the frequency of the status change notifications per unit time notified via each Phy. In FIG. 2A, status change notification frequency table 611a stores the frequency of the status change notification per unit time informed via each of Phys 11 through 16. Status change notification frequency table 611b stores the frequency of the status change notification per unit time notified via each of Phys 21 through 26.

The frequency of the status change notification stored in tables of status change notification frequency 611a and 611b will be reset to zero by corresponding control units 620a or 620b on every unit time. When the unit time of the frequency of status change notification stored in the tables of status change notification frequency 611a and 611b is defined as five seconds, the frequency of status change notification will be reset to zero every five seconds.

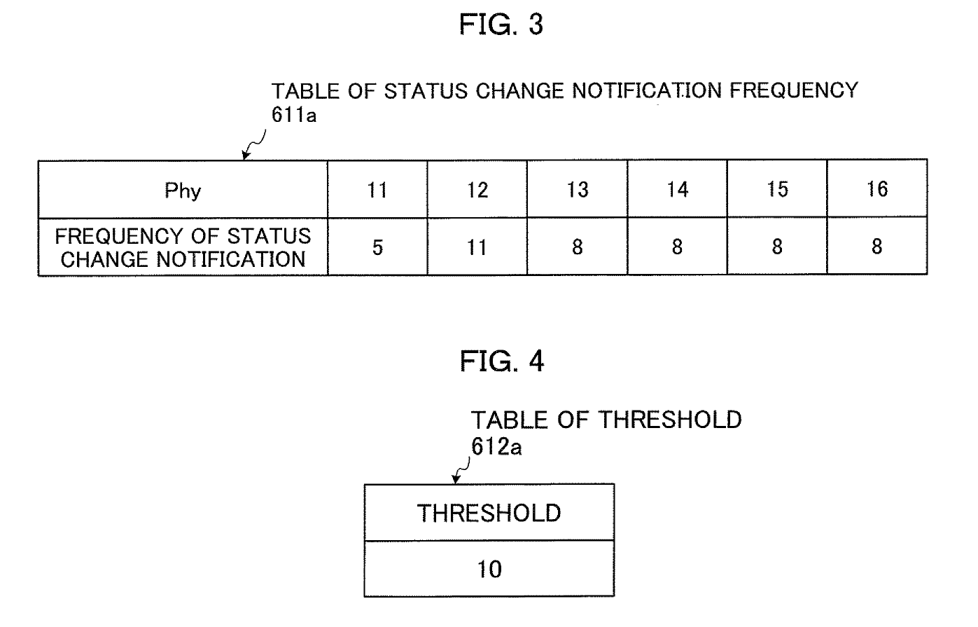

FIG. 3 shows an example of status change notification frequency table 611a. As shown in FIG. 3, status change notification frequency table 611a stores the frequency of the status change notifications for each Phy. Phy 11 in FIG. 3 is identical to Phy 11 in FIG. 2A. Similarly, Phys 12, 13, 14, 15 and 16 in FIG. 3 are identical to Phy 12, 13, 14, 15 and 16 in FIG. 2A respectively. In FIG. 3, the frequency of the status change notification per unit time informed via Phy 11 is 5. Similarly, the frequency of the status change notification per unit time informed via Phys 12, 13, 14, 15 and 16 is 11, 8, 8, 8 and 8, respectively. Status change notification frequency table 611b is similar to status change notification frequency table 611a.

Tables of threshold 612a and 612b store the frequency of the status change notification for each Phy. Threshold table 612a shown in FIG. 2A stores a threshold of the frequency of the status change notification informed via of Phys 11 through 16. Threshold table 612b shown in FIG. 2B stores a threshold of the frequency of the status change notification informed via each of Phy 21 through 26.

FIG. 4 shows an example of threshold table 612a. Threshold table 612a shown in FIG. 4 stores “10” as a threshold of the frequency of the status change notification informed via Phys 11 through 16. Threshold table 612b is similar to the table shown in FIG. 4.

Control unit 620a controls relay device 600a entirely, having notification unit 621a, monitor of status change notification frequency 622a and invalidation unit 623a. Similarly, control unit 620b controls relay device 600b entirely, having notification unit 621b, monitor of status change notification frequency 622b and invalidation unit 623b.

Notification unit 621a monitors HDDs 31 through 33 or 41 through 43 via corresponding Phys 11 through 16. When the status of any of the HDDs changes, the status change is notified to RoC 220a via Phy 17 by broadcasting. Further, notification unit 621a notifies the status change to RoC 220b via Phys 18, 28, 27 and control unit 620b.

After reporting the status change, notification unit 621a updates the frequency of the status change notification stored in status change notification frequency table 611a. For instance, when notification unit 621a detects status changes of HDD 43 five times via Phy 11 in three seconds, notification unit 621a issues status change notifications five times in three seconds. In other words, notification unit 621a updates the frequency of the status change notification informed via Phy 11 stored in status change notification frequency table 611a as 1, 2 . . . 5. As described above, the frequency of status change notification stored in status change notification frequency table 611a is reset to zero on every unit time by control unit 620a. After resetting the frequency of status change notification, notification unit 621a updates the frequency of status change notification corresponding to Phy 11 from zero.

Similarly, notification unit 621b monitors HDDs 31 through 33 or 41 through 43 via corresponding Phys 21 through 26. When the status of any of the HDDs changes, the status change is notified to RoC 220b via Phy 27 by broadcasting. At the same time, notification unit 621b issues the status change notification to RoC 220a via Phys 28, 18, 17 and control unit 620a. After reporting the status change, notification unit 621b updates the frequency of the status change notification stored in status change notification frequency table 611b, corresponding to the Phy through which the status change notification is informed.

Monitor of status change notification frequency 622a monitors whether the frequency of status change notification informed via any of Phys 11 through 16 exceeds the threshold. More specifically, monitor of status change notification frequency 622a compares the frequency of status change notification informed via any of the Phys that is stored in status change notification frequency table 611a with the threshold stored in threshold table 612a. When the frequency of status change notification informed via the Phy exceeds the threshold, monitor of status change notification frequency 622a sends a disablement request of the Phy including the identification number identifying Phy to be disabled to invalidation unit 623a. The identification number may be any value that can identify the Phys uniquely.

Referring to FIGS. 2 through 4, as the frequency of status change notification “5” that corresponds to Phy 11 does not exceed the threshold “10”, monitor of status change notification frequency 622a does not issue a disablement request of Phy 11 to invalidation unit 623a. Similarly, as the frequency of status change notification “8” informed via each of Phys 13 through 16 do not exceed the threshold “10”, monitor of status change notification frequency 622a does not issue disablement requests of Phys 13 through 16 including the identification numbers of each of the Phys to invalidation unit 623a.

Meanwhile, the frequency of status change notification “11” informed via Phy 12 exceeds the threshold “10”, therefore monitor of status change notification frequency 622a issues a disablement request of Phy 12 including the identification number of Phy 12 to invalidation unit 623a.

Similarly, monitor of status change notification frequency 622b compares the frequencies of status change notification informed via each of Phys 21 through 26 with the threshold stored in threshold table 612b. When any of the frequencies exceeds the threshold, monitor of status change notification frequency 622b issues a disablement request of the Phy to invalidation unit 623b.

Monitors of status change notification frequency 622a or 622b may monitor tables of status change notification frequency 611a and 611b before notification units 621a or 621b issue a status change notification or after issuing the notification or otherwise at any arbitrarily specified timing, e.g., per second.

When receiving the Phy disablement request from monitor of status change notification frequency 622a, invalidation unit 623a disables the Phy.

In FIGS. 2 through 4, as the frequency of status change notification “11” of Phy 12 exceeds the threshold “10”, invalidation unit 623a disables Phy 12 on receiving a disablement request of Phy 12 issued from monitors of status change notification frequency 622a.

Similarly, invalidation unit 623b disables a Phy specified with a Phy disablement request on receiving the disablement request issued from monitor of status change notification frequency 622b.

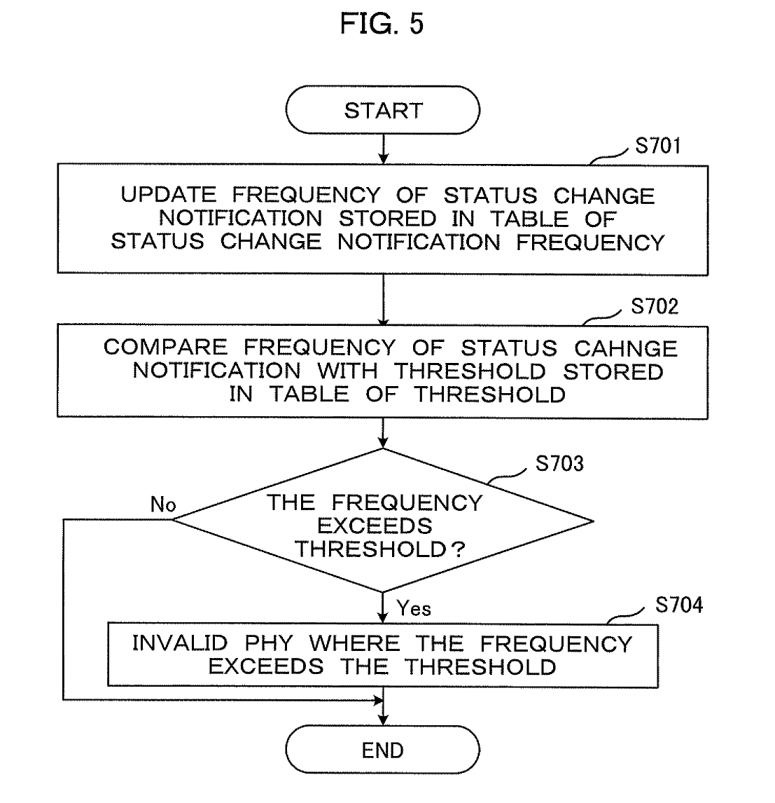

A Phy disablement process executed by relay device 600a will be disclosed. FIG. 5 is the flow chart showing a Phy disablement process executed by relay device 600a. FIG. 5 shows an example that relay device 600a executes a Phy disablement process after notification unit 621a issues a status change notification. As with relay device 600a, relay device 600b follows the same sequence.

As shown in FIG. 5, notification unit 621a monitors HDDs 31 through 33 via corresponding Phys 11 through 16. When the status of any of the HDDs changes, notification unit 621a notifies the status change. Further, notification unit 621a updates the frequency of status change notification corresponding to a Phy through which the status change is informed in operation S701.

Monitor of status change notification frequency 622a compares the frequencies of status change notification of each of Phys 11 through 16 stored in status change notification frequency table 611a with the threshold stored in threshold table 612a in operation S702.

When the frequency of status change notification corresponding to any Phy exceeds the threshold (operation S703, Yes), monitor of status change notification frequency 622a issues a Phy disablement request including the identification number of the Phy that the frequency of status change notification exceed the thresholds to invalidation unit 623a.

Invalidation unit 623a disables the Phy on receiving the Phy disablement request in operation S704.

In the embodiment describe above, notification units 621a and 621b issue the status change notifications and updates the frequency of status change notification stored in status change notification frequency table 611a or 611b. Monitors of status change notification frequency 622a and 622b compare the frequency of status change notification with the threshold. When the frequency of status change notification exceeds the threshold, a disablement request including the corresponding Phy's identification number is sent to invalidation unit 623a or 623b. Then invalidation units 623a or 623b disables the Phy on receiving the request. Therefore, RoCs 220a and 220b complete the configuration information update if the statuses of HDDs 31 through 33 or 41 through 43 change at very close intervals. Thus, the configuration information is updated to the latest information and issuing a write command to an unwritable storage medium can be avoided.

In the embodiment described above, all Phys has a common threshold. However, this invention is not limited to this embodiment. A threshold may be configured for each Phy. Configuring the threshold for each Phy is effective, specifically, when reliabilities of storage media connected to the Phys differ respectively. Generally, storage media with SATA have lower reliabilities compared with storage media with SAS. Therefore, a status of the storage medium with SATA may change more frequently than the storage medium with SAS. In the consideration of each storage medium's reliability, a threshold of the Phy connected with the storage medium with SATA may set higher compared with the storage medium with SAS.

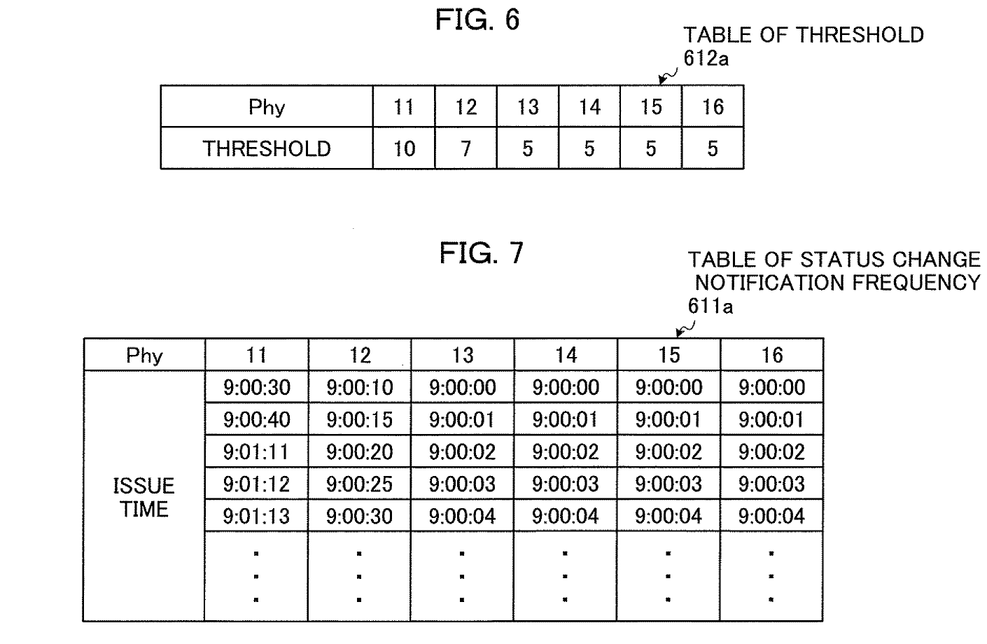

FIG. 6 shows an example of a threshold table providing thresholds for each Phy. In FIG. 6, the thresholds of Phys 11, 12, 13, 14, 15 and 16 are 10, 7, 5, 5, 5 and 5 respectively. In FIG. 3, the frequency of status change notification informed via Phy 11 is “5”, and the frequency does not exceed the threshold “10”. Therefore, Phy 11 is not disabled. Meanwhile, the frequency of status change notification informed via Phy 12 is “11”, and the frequency exceeds the threshold “7”. Thus, Phy 12 is disabled. Similarly, the frequencies of status change notification informed via Phys 13, 14,15 and 16 are “8”, which exceeds the threshold “5”. Therefore, the Phys are disabled.

In this embodiment, when a frequency of status change notification informed via a certain Phy exceeds a specific threshold, the Phy is disabled. However, this invention is not limited to the embodiment described above. A Phy may be disabled when a mean value of frequencies of status change notification informed via each Phy exceeds a threshold.

In examples shown in FIGS. 3 and 4, a mean value of frequencies of status change notification informed via Phys 11 through 16 is

8=(5+11+8+8+8+8)/6

which does not exceed the threshold “10” shown in FIG. 4. Hence, Phys 11 through 16 are not disabled even if the frequency of status change notification informed via ay Phy, Phy 12 in this case, is “11” and the frequency exceeds the threshold “10”. Meanwhile, when frequencies of status change notification informed via Phys 11 through 16 are 10, 8, 15, 11, 11 and 11, a mean value of frequencies is “11”, which exceeds the threshold “10”. Thus, Phys 11, 13, 14, 15 and 16 through which the frequencies of status change notification informed exceed the threshold are disabled.

In the embodiment described above, a Phy is disabled if a frequency of status change notification informed via the Phy exceeds a threshold. However, this invention is not limited to the embodiment. For example, when storage media connected with a Phy constructs RAID and the same data can be obtained from the other storage medium, the Phy is disabled.

For instance, HDDs 42 and 43 shown in FIG. 2A and FIG. 2B are mirrored in RAID 1 and a frequency of status change notification informed via Phy 11 exceeds the threshold, Phy 12 is checked that its function is disabled or not. If Phy 12 is not disabled, Phy 11 is disabled because data identical to data stored in HDD 43 can be obtained from HDD 42 via Phy 12. Meanwhile, if Phy 12 is disabled, Phy 11 is not disabled because data stored in HDDs 42 and 43 cannot be obtained.

When HDDs 41 through 43 shown in FIG. 2A and FIG. 2B construct RAID 5 and a frequency of status change notification informed via Phy 11 exceeds the threshold, Phys 12 and 13 are checked that their functions are disabled or not. If Phys 12 and 13 are not disabled, Phy 11 is disabled because data identical to data stored in HDD 41 through 43 can be obtained from HDDs 41 and 42 via Phys 12 and 13. Meanwhile, if it is determined that either of Phy 12 or 13 is disabled, Phy 11 is not disabled because the data stored in HDDs 41 through 43 cannot be obtained.

When determining which Phy will be disabled based on the storage media configuration in RAID as described above, the relay device may obtain configuration information of the storage media in RAID from the configuration information stored in the RoC. Otherwise, the configuration information on RAID may be stored in the memory unit of the relay device.

In the embodiment described above, the frequency of status change notification stored in status change notification frequency table 611a or 611b is reset to zero per unit time. However, the present invention is not limited to the embodiment. Tables of status change notification frequency 611a and 611b may be in any forms in so far as the table provides frequencies of status change notification per unit time.

Referring to FIG. 7, the other embodiment of the frequency of status change notification stored in status change notification frequency table 611a will be described. FIG. 7 shows an example of status change notification frequency table 611a providing time of the issues. As shown in FIG. 7, status change notification frequency table 611a stores the time when the status change notifications are issued in time sequence. The frequency of status change notification per unit time is counted for a unit time, i.e., 5 seconds. In FIG. 7, when the current time is “9:01:15” and the unit time is “5 seconds”, the frequency of status change notification informed via Phy 11 is “3” because the notifications are issued three times at “9:01:11”, “9:01:12” and “9:01:13” respectively. If the status change notification frequency table 611a is configured as shown in FIG. 7, the frequency of status change notification is not needed to be reset to zero per unit time. In FIG. 7, time is indicated in “time: minute: second” for convenience. Properly, time is indicated in “year: month: date: time: minute: second”.

For a configuration of Relay devices 600a and 600b shown in FIG. 2A and FIG.2B, many variations and modifications will be made within the scope of this invention. For instance, a function of control unit 620a included in relay device 600a can be realized by implementing software providing the equivalent function, executing the software by a specific calculation mean. An example of a structure of relay device 600a implementing the software realizing the functions of control unit 620a will be described below.

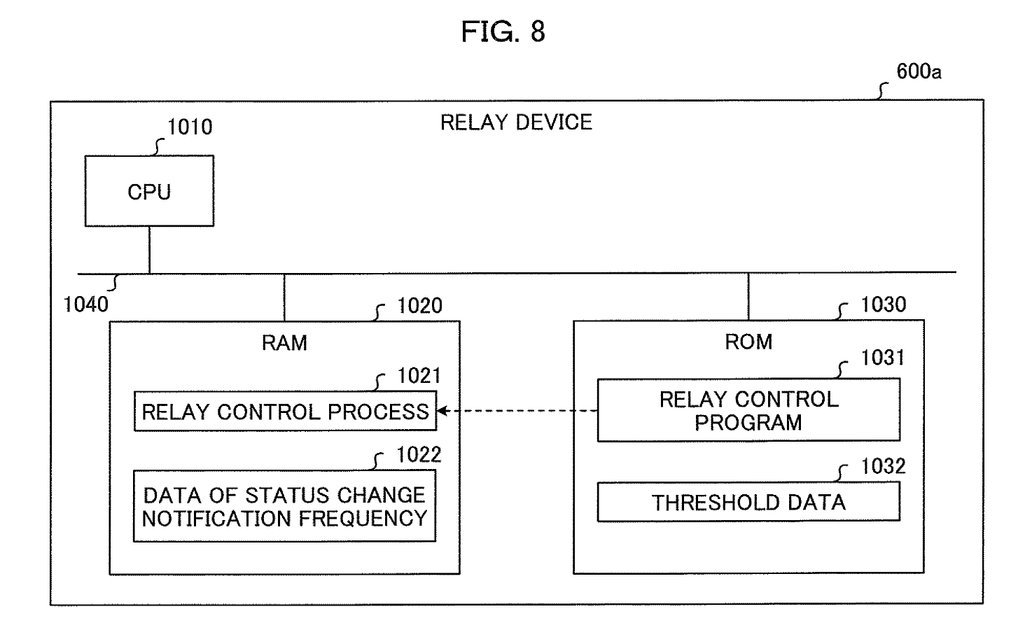

FIG. 8 is the function block diagram showing relay device 600a executing relay control program 1031. Relay control program 1031 is implemented the functions of control unit 620a as software. In FIG. 8, chief part of relay device 600a to execute relay control program 1031 are shown.

As shown in FIG. 8, relay device 600a has central processing unit (CPU) 1010 for executing various calculations, RAM 1020 for storing various types of information temporally and read-only-memory (ROM) 1030 serving as a nonvolatile memory on bus 1040. RAM 1020 and ROM 1030 serve as memory unit 610a shown in FIG. 2A.

ROM 1030 stores relay control program 1031 serving as control unit 620a and threshold data 1032 serving as threshold table 612a. RAM 1020 stores relay control process 1021 fetched from relay control program 1031 stored in ROM 1030 by CPU 1010 and data of status change notification frequency 1022 serving as status change notification frequency table 611a shown in FIG. 2A.

Relay control process 1021 loads information read out from threshold data 1032 to RAM 1020 as appropriate and executes various data processes according to the data loaded.

According to the embodiments of the present invention, a higher level device is capable of handling frequently changing status of a storage medium in updating configuration information.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A relay device having a plurality of physical ports connecting a storage medium respectively, and for relaying data between a higher level device storing configuration information of a storage device and the storage medium, the relay device comprising:
a notification unit for issuing a status change notification reporting that a status of the storage medium connected with said physical port changes to said higher level device when the status change of the storage medium is detected;
a monitor unit for monitoring whether the frequency of the status change notification informed via said physical port exceeds a threshold; and
an invalidation unit for invalidating a function of the physical port when said monitor unit detects that the frequency of the status change notification informed via said physical port exceeds the threshold.

2. The relay device according to claim 1, further comprising:
a memory unit for storing said frequency of status change notification for each of the physical ports and a threshold memory unit for storing said threshold,
wherein said notification unit updates the frequency of status change notification corresponding to the physical port stored in said frequency of status change notification memory unit when the status change of the storage medium connected to said physical port is detected, and
wherein said monitor unit monitors whether the frequency of the status change notification stored in said frequency of status change notification memory unit exceeds said threshold stored in said threshold memory unit for each physical port.

3. The relay device according to claim 1, further comprising:
a threshold memory unit for storing said threshold for each of the physical ports,
wherein said monitor unit monitors whether the frequency of the status change notification informed via each of said physical ports exceeds the threshold corresponding to the physical port stored in said threshold memory unit.

4. The relay device according to claim 1, wherein
said monitor unit monitors whether a mean value of the frequencies of the status change notification informed via all of the physical ports exceeds the threshold.

5. The relay device according to claim 1, wherein
said monitor unit detects whether the frequency of status change notification informed via said physical port exceeds the threshold in said monitor unit, when the frequency exceeds the threshold, said invalidation unit judges whether the storage medium connected with the physical port constructs RAID, when the storage medium does not constructs RAID, the physical port is disabled and when the storage medium constructs RAID and an identical data can be obtained from other storage medium in the RAID, the physical port is disabled.

6. A relay method to be executed by a relay device for relaying data between a higher level device having a plurality of physical ports connected with a storage medium and the storage medium respectively, the relay method comprising:
reporting a status change of the storage medium connected to said physical port to said higher level device when the status of the storage medium is detected;
monitoring whether a frequency of the status change notification informed via said physical port exceeds a threshold; and
invalidating a function of the physical port when the frequency of the status change notification informed via said physical port is judged that the frequency exceeds the threshold in said frequency of status change notification monitoring operation.

7. The relay method according to claim 6, wherein
the frequency of status change notification corresponding to the physical port stored in the frequency of status change notification memory unit for storing said frequency of status change notification for each physical port is updated when the status change of the storage medium connected with the physical port is detected in said notification operation, and
wherein the frequency of status change notification stored in said frequency of status change notification memory unit is monitored whether the frequency exceeds the threshold stored in said threshold memory unit for each physical port in said frequency of status change notification monitoring operation.

8. The relay method according to claim 6, wherein
the frequency of the status change notification informed via said physical port is monitored whether the frequency exceeds a threshold corresponding to the physical port stored in the threshold memory unit for storing the threshold for each physical port in said frequency of status change notification monitoring operation.

9. The relay method according to claim 6, wherein
a mean value of the frequencies of status change notification informed via all of the physical ports is monitored whether the mean value exceeds the threshold in said frequency of status change notification monitoring operation.

10. The relay method according to claim 6, wherein
said status change notification monitoring operation detects whether the frequency of status change notification informed via said physical port exceeds the threshold, when the frequency exceeds the threshold, said invalidation operation judges whether the storage medium connected with the physical port constructs RAID, when the storage medium dose not construct RAID, the physical port is disabled and when the storage medium constructs RAID and the identical data can be obtained from other storage medium in the RAID, the physical port is disabled.

11. A recording medium for storing a relay control program executed by a relay device for transmitting data between a higher level device having a plurality of physical ports connected with a storage medium and the storage medium, wherein
said relay control program executes the following operations with a calculator:
a notification operation for reporting a status change of the storage medium to said higher level device when the status change of the storage medium connected with said physical port is detected,
a frequency of status change notification monitoring operation for monitoring whether the frequency of the status change notification informed via said physical port exceeds the specific threshold for each physical port, and
an invalidation operation for invalidating said physical port when the frequency of the status change notification informed via said physical port is judged that it exceeds the specific threshold in said frequency of status change notification monitoring operation.

12. The recording medium according to claim 11, wherein
said notification operation updates the corresponding frequency of status change notification stored in the frequency of status change notification memory unit for storing said frequency of status change notification for each physical port when a status change of the storage medium connected with the physical port is detected, and
wherein the frequency of the status change notification stored in said frequency of status change notification memory unit is monitored for each physical port whether it exceeds said threshold stored in said threshold memory unit for storing said threshold.

13. The recording medium according to claim 11, wherein
the frequency of the status change notification informed via said physical port is monitored whether it exceeds the threshold corresponding to the physical port stored in the thereshold memory unit for storing said threshold for each physical port in said frequency of status change notification monitoring operation.

14. The recording medium according to claim 11, wherein
the mean value of the status change notification informed via all of the physical ports is monitored whether it exceeds the threshold in said frequency of status change notification monitoring operation.

15. The recording medium according to claim 11, wherein
said frequency of status change notification monitoring operation detects whether the frequency of status change notification informed via said physical port exceeds the threshold, when the frequency exceeds the threshold, said invalidation operation judges whether the storage medium connected with the physical port constructs RAID, if the storage medium does not construct RAID, the physical port is disabled and when the storage medium constructs RAID and the identical data can be obtained from other storage medium constructing RAID, the physical port is disabled.
